(19) United States
(12) Patent Application Publication
(10) Pub. No.: US 2025/0173772 A1
(43) Pub. Date: May 29, 2025

(54) SERVER DEVICE, SERVICE PROVIDING METHOD, AND RECORDING MEDIUM

(71) Applicant: Rakuten Group, Inc., Tokyo (JP)

(72) Inventor: Sangjin OH, Tokyo (JP)

(73) Assignee: Rakuten Group, Inc., Tokyo (JP)

(21) Appl. No.: 18/958,580

(22) Filed: Nov. 25, 2024

(30) Foreign Application Priority Data
Nov. 29, 2023 (JP) 2023-201766

(51) Int. Cl. G06Q 30/0601

(52) U.S. Cl. CPC G06Q 30/0623; G06Q 30/0641; G06Q 30/0631

(57) ABSTRACT

A server device generates product information in which a product put up for sale on an electronic flea market is arranged in a predetermined order according to access to the electronic flea market by a user and also acquires access information to the electronic flea market from a seller of a product put up for sale on the electronic flea market. The server device rearranges an arrangement of a product indicated by the generated product information, based on the acquired access information, and provides the user with the product information after an arrangement is rearranged.

### CROSS-REFERENCE TO RELATED APPLICATIONS

This application claims the benefit of Japanese Patent Application No. 2023-201766, filed on Nov. 29, 2023, the entire disclosure of which is incorporated by reference herein.

### FIELD OF THE INVENTION

This application relates to a server device, a service providing method, and a recording medium.

### BACKGROUND OF THE INVENTION

In services provided via the Internet, various systems for improving convenience for users have been proposed. For example, in Unexamined Japanese Patent Application Publication No. 2009-279345, a network system that makes it difficult for a team that has not logged in to a server for a long period of time and has neglected the network system to compete against a team including active players is disclosed.

However, since in the above-described network system, it becomes difficult to compete against a team including users who have not logged in to the server for a long period of time, when the network system is applied to, for example, a system in which a user of an electronic flea market puts up a product for sale, it becomes difficult to buy a product that a user who has not logged in for a long period of time puts up for sale, and the network system has room for improvement from a viewpoint of improving convenience for users.

The present disclosure has been made to solve a problem as described above, and an objective of the present disclosure is to provide a server device, a service providing method, and a recording medium that are capable of improving convenience for a user.

### SUMMARY OF THE INVENTION

A server device according to a first aspect of the present disclosure includes one or more processors, and the processors
generate product information in which a product put up for sale on an electronic flea market is arranged in a predetermined order according to access to the electronic flea market by a user,
acquire access information to the electronic flea market from a seller of a product put up for sale on the electronic flea market,
rearrange an arrangement of a product indicated by the generated product information, based on the acquired access information, and
provide the user with the product information after an arrangement is rearranged.

According to the present disclosure, a server device, a reservation method, and a recording medium that are capable of suitably performing simultaneous reservation can be provided.

### BRIEF DESCRIPTION OF DRAWINGS

A more complete understanding of this application can be obtained when the following detailed description is considered in conjunction with the following drawings, in which:

FIG. 1 is a diagram illustrating a relationship between a server device and information terminals;

FIG. 2 is a block diagram illustrating an example of the server device;

FIG. 3 is an explanatory diagram illustrating an example of product-for-sale information;

FIG. 4 is an explanatory diagram illustrating an example of login information;

FIG. 5 is a flowchart illustrating an example of processing of the entire system;

FIG. 6 is an explanatory diagram illustrating a display example of an information terminal;

FIG. 7 is an explanatory diagram illustrating another display example of the information terminal;

FIG. 8 is an explanatory diagram illustrating still another display example of the information terminal; and

FIG. 9 is an explanatory diagram illustrating still another display example of the information terminal.

### DETAILED DESCRIPTION OF THE INVENTION

### Overall Configuration

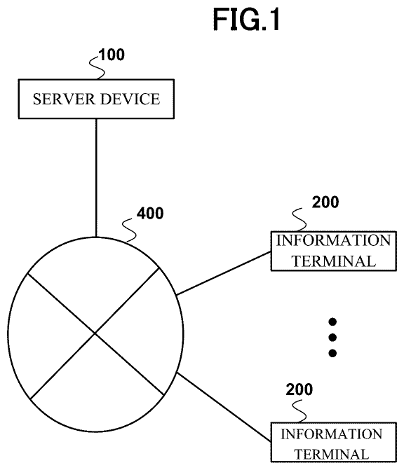

A server device, a service providing method, and a recording medium according to an embodiment for embodying the present disclosure are described below in detail with reference to the drawings. Note that the same or corresponding parts in the drawings are designated by the same reference numerals. As illustrated in FIG. 1, a server device 100 according to an embodiment of the present disclosure communicably connects to an information terminal 200 via a computer communication network 400, such as the Internet.

The server device 100 is a personal computer (PC), a server, or the like (a so-called computer) that manages a system, such as an electronic flea market, on which a user puts up a product for sale and is capable of mutually communicating with each information terminal 200 via the computer communication network 400. Specifically, the server device 100 has information about a product put up for sale from an information terminal 200, information about a buyer, and functions of performing payment and the like. In addition, the server device 100 in the embodiment has a function of managing a login date of each seller on the electronic flea market and rearranging an arrangement order of products on an electronic flea market service according to the login date. Note that the system that the server device 100 manages is only required to be a system in which an individual provides a service, such as an auction site and a private lodging site, in addition to an electronic flea market. In addition, although in the embodiment, the following description is made using as an example a case where rearrangement of an arrangement order of products is performed according to login dates, the rearrangement of an arrangement order of products may be performed according to not only login dates but also login dates and times.

The information terminal 200 is an information terminal (a so-called computer) that a user owns, such as a smartphone, a tablet, and a personal computer (PC). The information terminal 200 performs processing of registering a product to be put up for sale on the electronic flea market in the server device 100, processing of buying a product put up for sale on the electronic flea market, and the like, in response to an operation performed by the user.

### (Functional Configuration of Server Device)

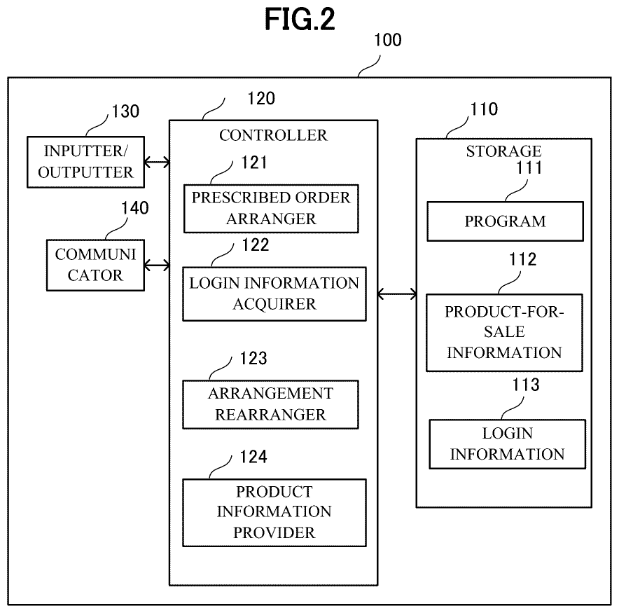

Next, with reference to FIG. 2, a configuration of the server device 100 is described.

As illustrated in FIG. 2, the server device 100 includes a storage 110, a controller 120, an inputter/outputter 130, a communicator 140, and a system bus (illustration is omitted) connecting the foregoing to one another.

The storage 110 includes a read only memory (ROM), a random access memory (RAM), and the like. The ROM stores a program 111 that a central processing unit (CPU) of the controller 120 executes, various types of data (illustration is omitted) that are required for execution of the program 111 in advance, product-for-sale information 112, and login information 113.

The program 111 is a program that performs reservation processing, which is described later, and is stored in the storage 110 in advance.

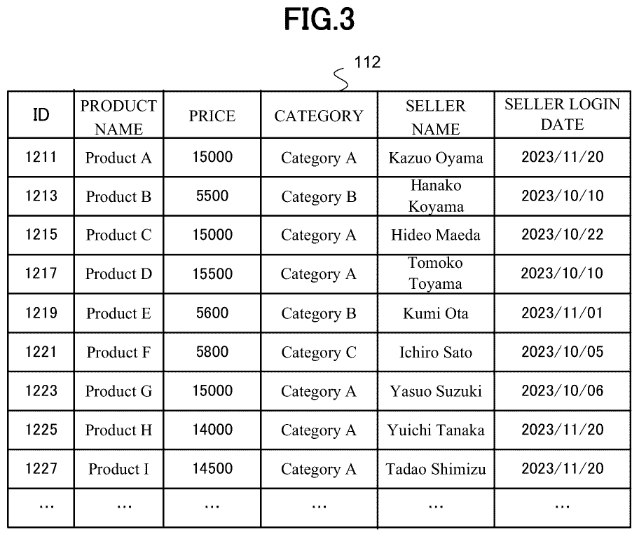

The product-for-sale information 112 is information about a product that is put up for sale by a user. Specifically, in the product-for-sale information 112, information including an ID for identifying a product, a product name, a price, a category indicating a classification of the product, a seller name for identifying a seller, and a seller login date indicating a login date of the seller is included, as illustrated in FIG. 3. Note that the seller name is only required to be a user name that has been registered, such as a handle name. In addition, information about a user ID for identifying a user and an on-sale date indicating a date on which a product is put up for sale may be included in addition to the above-described information. An on-sale date and time may be included in the product-for-sale information 112 instead of only an on-sale date. Among the product-for-sale information 112 illustrated in FIG. 3, the ID for identifying a product, the product name, the price, the category indicating a classification of the product, and the seller name for identifying a seller are stored when the product is put up for sale by a user, that is, at a timing at which the product is registered in the server device 100. On the other hand, with regard to the seller login date, although an on-sale date and time are once stored as a login date at a timing at which the product is put up for sale, the login date is updated by a latest login date of each seller every time each user starts an application and logs in to the electronic flea market from an information terminal 200 of the user.

In a case where today is Nov. 20, 2023, it is indicated, in the example illustrated in FIG. 3, that a seller of a product having a product ID “1211” has logged in today, and a seller of a product having a product ID “1213” has not logged in since Oct. 10, 2023.

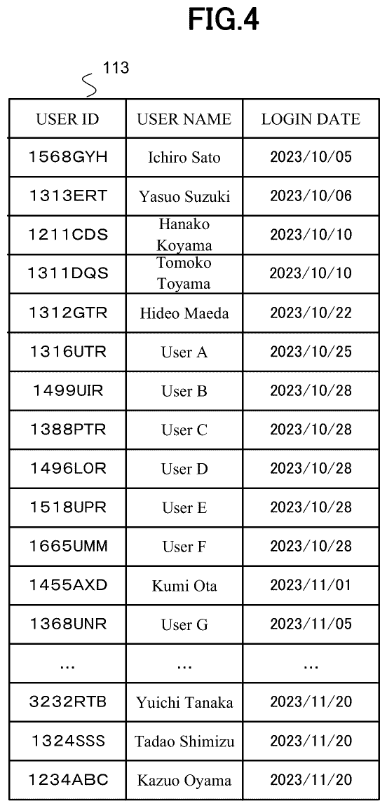

The login information 113 is time series information that associates a user ID identifying a user including a seller and a prospective buyer, and a user name of the user with a login date of the user, as illustrated in FIG. 4. The login information 113 is registered in the storage 110 every time a user logs in. Note that in the example illustrated in FIG. 3, among all users, prospective buyers are designated by users A to G and sellers are designated by names other than the users A to G, to facilitate understanding.

The controller 120 includes the CPU, an application specific integrated circuit (ASIC), and the like. The controller 120 operates in accordance with the program 111, which is stored in the storage 110, and performs processing in accordance with the program 111. The controller 120 includes, as major functional parts provided by the program 111 stored in the storage 110, a prescribed order arranger 121, a login information acquirer 122, an arrangement rearranger 123, and a product information provider 124.

The prescribed order arranger 121 is a functional part that, when a login to the electronic flea market is performed based on an operation performed by a user of an information terminal 200, arranges products in a prescribed order that is a predetermined order. The prescribed order in the embodiment is a “recommended order” that causes products to be arranged in order of recommendation of the products to the user. Specifically, when a login to the electronic flea market is performed, a product information request is transmitted from the information terminal 200 to the server device 100. The prescribed order arranger 121 arranges a plurality of products that is put up for sale in the recommended order, based on information about the user included in the received product information request, using artificial intelligence (AI). Note that although in the embodiment, an example in which the prescribed order is the “recommended order” is described, the prescribed order may be another arrangement order, such as a “most recent”. In addition, it may be configured such that the prescribed order can be set to an arrangement order that the user desires from among a plurality of types of arrangement orders. Note that the arrangement in the “recommended order” using AI is only required to be performed based on, for example, a past purchase history or a past viewing history by the user. The prescribed order arranger 121 is a functional part that generates product information about products put up for sale on the electronic flea market that are arranged in a predetermined order.

The login information acquirer 122 is a functional part that acquires a login date of a seller of each of products put up for sale. Specifically, the login information acquirer 122 acquires a latest date on which a seller logged in, from the login information 113 stored in the storage 110. The acquisition of a login date may, for example, be performed in such a manner that a latest login date of a user who has the same user name as a seller name included in the product-for-sale information 112 illustrated in FIG. 3 is acquired from the login information 113 illustrated in FIG. 4. Note that although in the embodiment, an example in which a login date is acquired is described, it may be configured to acquire a date and time instead of acquiring only a date, and in such a case, the login date and time are only required to be stored in the login information 113. In addition, a user ID may be used in the acquisition of a login date. In this case, the user ID is only required to be included in the product-for-sale information 112 illustrated in FIG. 3.

The arrangement rearranger 123 is a functional part that rearranges an arrangement of products that are arranged in the prescribed order by the prescribed order arranger 121, based on a login date of a seller acquired by the login information acquirer 122. Specifically, the arrangement rearranger 123 has a function of decreasing an arrangement priority of a product of a seller who has not logged in for a predetermined period or longer among products that are arranged in the “recommended order”, which causes products to be arranged in order of recommendation of the products to the user. That is, the arrangement rearranger 123 has a function of decreasing an arrangement priority of a product put up for sale by a user who satisfies a predetermined condition, based on a login date of the seller acquired by the login information acquirer 122. Note that the predetermined period can be arbitrarily changed and, in the embodiment, it is assumed that two weeks is set as the predetermined period. The arrangement rearranger 123 is a functional part that has a function of decreasing an arrangement priority of a product of a seller who has not logged in for a predetermined period or longer and also arranging such products having the arrangement priorities decreased in descending order of login date, and generates product information of this arrangement.

The product information provider 124 has a function of providing an information terminal 200 with product information about products having the arrangement rearranged by the arrangement rearranger 123 and causing the information terminal 200 to display products put up for sale in the arrangement. Specifically, the product information provider 124 has a function of providing products having the arrangement rearranged by the arrangement rearranger 123 to an information terminal 200 from which a product information request is transmitted.

The inputter/outputter 130 is a device that includes a keyboard, a mouse, a camera, a microphone, a liquid crystal display, an organic electro-luminescence (EL) display, or the like and that performs inputting and outputting of various types of data.

The communicator 140 is a device for the server device 100 to communicate with another information terminal, such as an information terminal 200, via the computer communication network 400. The foregoing is the configuration of the server device 100.

### (Operation)

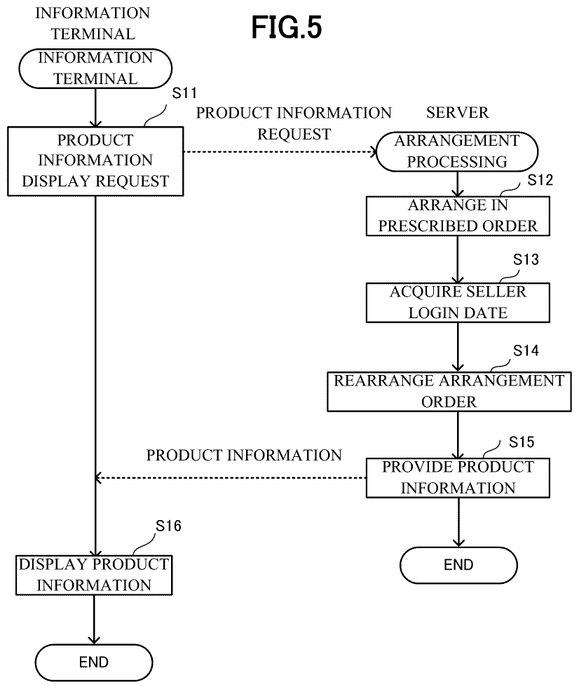

Next, operation of the server device 100 and an information terminal 200 is described with reference to FIGS. 5 to 7. FIG. 5 is a flowchart illustrating an example of processing performed by the entire system, such as arrangement processing in the server device 100 and display processing in the information terminal 200. Note that in the embodiment, the following description is made assuming that the prescribed order is the “recommended order” and the predetermined condition for decreasing an arrangement priority of a product (a low access condition) is set to a condition requiring that a seller “has not logged in for two weeks or longer”, as described above. It is also assumed that the product-for-sale information 112 illustrated in FIG. 3 is stored in the storage 110 of the server device 100 and products illustrated in the drawing are put up for sale. It is further assumed that the login information 113 illustrated in FIG. 4 is stored in the storage 110 of the server device 100.

First, an operation of the information terminal 200 performed by the user causes the display processing illustrated in FIG. 5 to be started. Specifically, by an operation to start the application of the electronic flea market being performed by the user, a login to the electronic flea market is performed, and the display processing is started. When the display processing is started, the information terminal 200 makes a product information display request by transmitting a product information request to the server device 100, in order to display products put up for sale (step S11). Specifically, in the processing in step S11, the information terminal 200 transmits a product information request in order to display products that are currently put up for sale. The product information request being transmitted to the server device 100 causes a login date of the user to be stored in the storage 110 of the server device 100 as the login information 113.

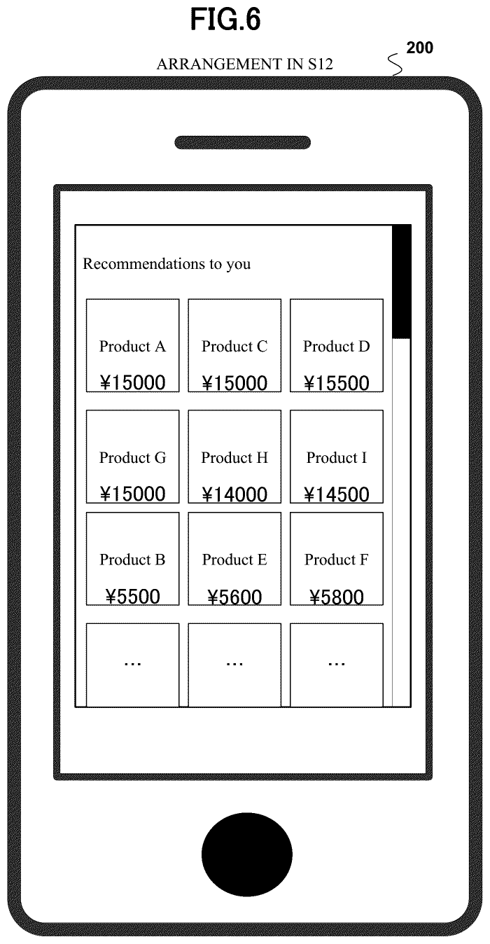

On the server device 100 side, when the server device 100 receives the product information request from the information terminal 200, the server device 100 arranges the product put up for sale in the prescribed order by the function of the prescribed order arranger 121 (step S12). Specifically, in the processing in step S12, the prescribed order arranger 121 arranges a plurality of products indicated by the product-for-sale information 112 illustrated in FIG. 3 in the recommended order, using AI. Note that as described above, the arrangement in the “recommended order” using AI is only required to be performed based on, for example, a past purchase history or a past viewing history of the user and when, for example, the products after the arrangement are displayed on the information terminal 200 at this time point, the products are only required to be displayed in an arrangement as illustrated in FIG. 6. In the example illustrated in FIG. 6, an example in which the most recommended products to the user are products belonging to a category A and the second most recommended products are products belonging to a category B is illustrated.

Returning to FIG. 5, after the controller 120 performs the processing in step S12, the controller 120 acquires a login date of each seller by the function of the login information acquirer 122 (step S13). Specifically, in the processing in step S13, the login information acquirer 122 acquires a latest date on which a seller of each product put up for sale logged in from the login information 113. Note that as described above, it may be configured to acquire a date and time instead of acquiring only a date, and in such a case, the login date and time are only required to be stored in the login information 113. For example, in the case of the login information 113 illustrated in FIG. 4, in the processing in step S13, the controller 120 acquires “2023/10/05” as a latest login date of “Ichiro Sato” and stores “2023/10/05” as a seller login date corresponding to the seller “Ichiro Sato” in the product-for-sale information 112 illustrated in FIG. 3.

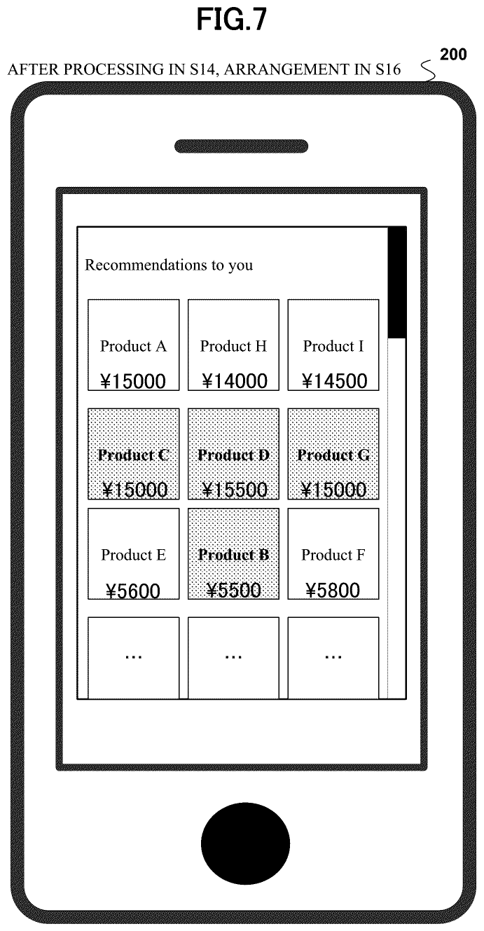

After the controller 120 performs the processing in step S13, the controller 120 rearranges the arrangement order of the products arranged in the prescribed order in the processing in step S12, based on the login date of the seller acquired in the processing in step S13, by the function of the arrangement rearranger 123 (step S14). Specifically, in the processing in step S14, the arrangement rearranger 123 decreases an arrangement priority of a product of a seller who has not logged in for a predetermined period (two weeks) or longer among the products that are arranged in the “recommended order” in the processing in step S12, and also arranges the product having the arrangement priority decreased in descending order of login date. For example, in the case where today is Nov. 20, 2023, since among the products indicated by the product-for-sale information 112 illustrated in FIG. 3, sellers of a “product B”, a “product C”, a “product D”, and a “product G” are sellers who have not logged in for two weeks or longer, the arrangement rearranger 123 decreases the arrangement priorities of the products of the sellers and arranges the products having the arrangement priorities decreased in descending order of login date, in the processing in step S14. Therefore, when after the processing in step S14 is performed, the products after the arrangement are displayed on the information terminal 200, an arrangement as illustrated in FIG. 7 is displayed. Note that in the processing in step S14, processing of changing display forms of the products having the arrangement priorities decreased to a special form is also performed in such a way that the products are displayed in a form that enables the user to visually recognize that the products are products having the arrangement priorities decreased (for example, the display forms of the “product B”, the “product C”, the “product D”, and the “product G” in FIG. 7). Note that in the example illustrated in the drawings, an example in which the most recommended products to the user are products belonging to the category A and the second most recommended products are products belonging to the category B is illustrated, and in the processing in step S14, processing of decreasing arrangement priorities within products belonging to the same category is performed.

Returning to FIG. 5, after the controller 120 performs the processing in step S14, the controller 120 provides the information terminal 200 with product information about the products having the arrangement rearranged in the processing in step S14 by the function of the product information provider 124 (step S15) and terminates the arrangement processing. Specifically, in the processing in step S15, the product information provider 124 provides the information terminal 200 from which the product information request is transmitted with information about the products having the arrangement rearranged in the processing in step S14 in conjunction with the arrangement order.

On the information terminal 200 side, when the information terminal 200 receives the product information from the server device 100, the information terminal 200 displays the received product information on a display screen (step S16) and terminates the display processing. Specifically, in the processing in step S16, the information terminal 200 displays, as illustrated in FIG. 7, the “product B”, the “product C”, the “product D”, and the “product G” with the arrangement priorities thereof decreased compared with the case illustrated in FIG. 6. In addition, the information terminal 200 displays the product having the display priorities decreased in a special form that enables the product to be identified. Note that the example illustrated in FIGS. 6 and 7 indicates an example in which, as described above, the most recommended products to the user are products belonging to the category A and the second most recommended products are products belonging to the category B.

The foregoing is the operation of the server device 100 and the information terminal 200. As described above, according to the server device 100 in the embodiment, since an arrangement priority of a product of a seller who has not logged in recently is decreased, it becomes difficult for a user (a prospective buyer) on the electronic flea market to find the product. On the other hand, since the server device 100 does not make it impossible to buy a product from a seller who has not logged in recently but makes it possible to buy the product when a buyer searches for the product in detail, convenience for a user can be improved. There is a possibility that contact after purchase from a seller who has not logged in recently is late. Therefore, by decreasing a display priority of a product of such a seller and thereby making the product difficult for users to find and further making a product of such a seller stand out through changing the display form of the product to a special form and thereby making it visually recognizable for the user that there is a possibility that contact after purchase from the seller is late, it is possible to give the user a sense of security and also improve convenience.

### (Variations)

Note that the present disclosure is not limited to the above-described embodiment and various modifications and applications are possible. For example, the server device 100 according to the above-described embodiment does not have to include all the technical features described above and may be a server device including a portion of the configuration described in the above-described embodiment to solve at least one problem in conventional technology. In addition, at least some of variations described below may be combined.

Although in the above-described embodiment, an example in which the server device 100 rearranges an arrangement order of a product according to a login date is described, the embodiment is only an example. A criterion for rearrangement of an arrangement priority of a product is not limited to a login date, and it may be configured to, for example, count login frequency after a product is put up for sale with respect to each seller and decrease an arrangement priority of a product of a seller having a low login frequency. Specifically, it is only required to decrease an arrangement priority of a product of a seller having a login frequency less than or equal to a predetermined frequency. In addition, both a login date and login frequency may be used, and it may, for example, be configured such that with regard to sellers whose login dates are the same day, a display priority of a product of a seller having a lower login frequency is decreased. Because of this configuration, a product of a seller who has a higher possibility that contact after purchase is late can be made more difficult to find, and convenience for a user can be improved. In addition, the criterion for rearrangement of an arrangement priority of a product is not limited to a login date and login frequency, and the rearrangement of an arrangement priority of a product may be determined based on, for example, “the expected number of days from purchase to contact” that a seller sets in such a manner that the longer “the expected number of days from purchase to contact” is, the lower a display priority is. Further, it may be configured to decrease a display priority in a stepwise manner according to the number of days for which a seller has not logged in, such as decreasing the display priority by 10 places when the seller has not logged in for a day and decreasing the display priority by 20 places when the seller has not logged in for two days. Further, although in the above-described embodiment, an example in which an arrangement priority of a product of a seller whose latest login date is two weeks or more before a present day, that is, a seller who has not logged in for two weeks or longer, is decreased is described, it may be configured such that on the contrary to the example, an arrangement priority of such a product is increased and a seller who has a possibility that contact after purchase is late is caused to stand out. Because of this configuration, it is possible to prompt the user to pay attention to such a product. Note that a display form in the case of increasing an arrangement priority may be set to a form different from a display form in the case of decreasing an arrangement priority. In addition, it may be configured such that an arrangement priority of a product of a seller whose response from purchase to contact is fast, such as a seller who logs in every day, is increased. That is, it may be configured such that a seller having a high access frequency is identified as a seller satisfying a high access condition and an arrangement priority of a product of the seller is increased. Because of this configuration, possibility of smooth sales can be increased and convenience for a user can be improved. Note that an access frequency serving as the high access condition is only required to be able to be arbitrarily set.

In addition, although in the above-described embodiment, an example in which after the processing in step S12 in FIG. 5 is performed, the processing in steps S13 and S14 is performed is described, the process is only an example. For example, the processing in step S13 may be performed first and the processing in step S14 may also be performed within the processing in step S13.

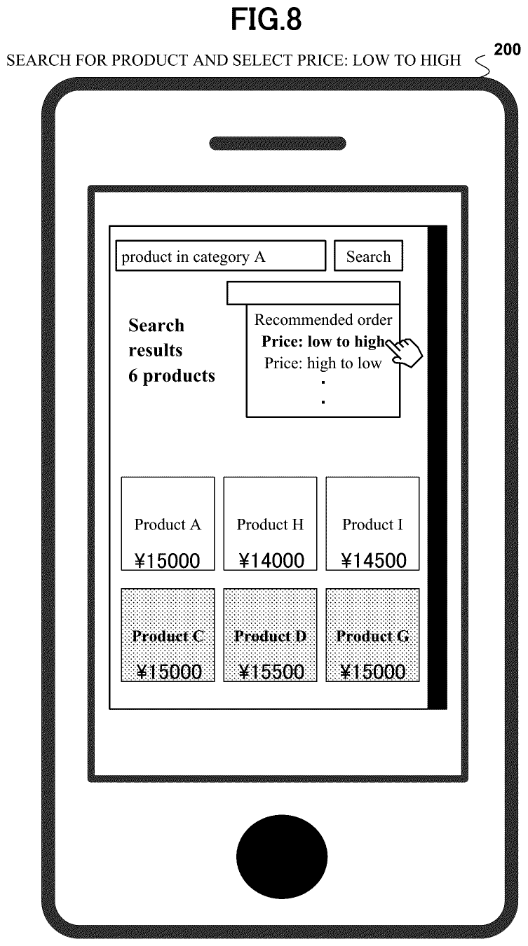

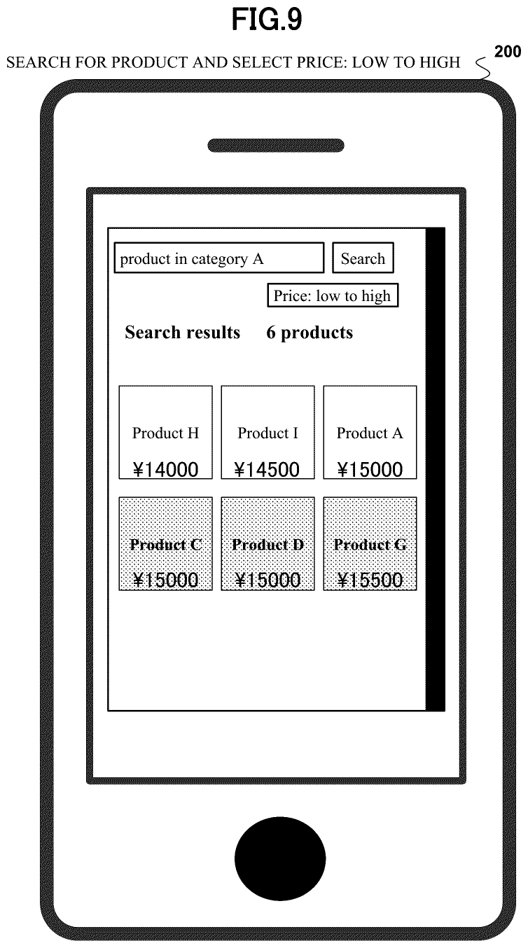

In addition, although in the above-described embodiment, an example in which the server device 100 decreases an arrangement priority of a product is described, the process may be performed by the information terminal 200, and in this case, the information terminal 200 is only required to include the function of the arrangement rearranger 123 in the above-described embodiment. In addition, information about a login date of each seller is only required to be transmitted from the server device 100 to the information terminal 200. For example, when after the processing in step S16 illustrated in FIG. 5 is performed and products are arranged as illustrated in FIG. 7, a “product belonging to the category A” is searched for as illustrated in FIG. 8 and the products are arranged in “Price: low to high” by the user, the arrangement is only required to be performed by the function of the arrangement rearranger 123 that the controller of the information terminal 200 includes. Specifically, as illustrated in FIG. 9, it is only required to decrease an arrangement priority of a product of a seller who has not logged in for a predetermined period or longer within products with the same price. In the example illustrated in FIG. 9, since among six products belonging to the category A, the “product C”, the “product D”, and the “product G” of the “product A”, the “product C”, the “product D”, and the “product G” that have the same price are products the display priorities of which are to be decreased, it is only required that the “product C”, the “product D”, and the “product G” are arranged in descending order of login date and the “product A” is displayed at the top of products with the same price. Note that differing from the above configuration, it may be configured such that based on selection of “Price: low to high” illustrated in FIG. 8 on the information terminal 200 side, the server device 100 changes an arrangement of products and transmits product information after the change to the information terminal 200, thereby displaying the products in an arrangement illustrated in FIG. 9.

In addition, although in the above-described embodiment, an example in which a product is displayed in a form enabling the user to visually recognize that the product is a product having the arrangement priority decreased as illustrated in FIG. 7, that is, an example in which the display form of a product of a seller having a possibility that the number of days from purchase to contact is late is changed to a special form, is described, the configuration is only an example. In addition to the above configuration, it may be configured to display, by a message, that a product of a seller has a possibility that the number of days from purchase to contact is late. Because of this configuration, it is possible to prompt the user to pay more attention to such a product and improve convenience.

In addition, it may be configured such that when a product having the arrangement priority decreased is viewed, the seller is notified of the viewing. Because of this configuration, it is possible to prompt a seller who has not logged in recently to log in and to reduce the number of days from purchase to contact, and convenience for a user can be improved.

In addition, although in the above-described embodiment, an example in which an arrangement order of products are rearranged is described, a product of a seller who has not logged in for a predetermined removal period, such as three months or longer, is only required to be removed in the processing in step S14 in FIG. 5 and excluded from products to be displayed to a user. Note that a product of such a seller may be configured to be able to be viewed only when, for example, the product is “registered as a favorite” in a watch list or the like. Because of this configuration, a product of a seller who has seldom logged in can be restricted from being viewed and trouble after purchase can be prevented. In addition, when a product is configured to be able to be viewed only when the product is “registered as a favorite” in a watch list or the like, it may be configured to notify a user who has “registered as a favorite” the product that the seller of the product has seldom logged in and there is a high possibility that contact from the seller is late. Because of this configuration, not only confusing users but also causing a trouble can be prevented. In addition, a product of such a seller may be brought into, for example, a drafted state instead of being removed. In this case, it is only required to notify the seller that the product has been brought into the drafted state. The drafted state is a state before a product is put up for sale and is a state in which the product, although being stored in the server device 100, is not displayed to the user.

Note that the server device 100 and the information terminal 200 according to the above-described embodiment can be achieved using a general computer without depending on a dedicated device. For example, the server device 100 that performs the above-described processing may be configured by installing, from a recording medium storing a program to cause the computer to perform one of the above-described types of processing, the program in the computer. In addition, the server device 100 and the information terminal 200 may be configured by a plurality of computers operating in collaboration with one another.

In addition, when the above-described functions are achieved by sharing of operation between an operating system (OS) and an application or collaboration between the OS and the application, only programs other than the OS may be stored in the medium.

In addition, it is possible to superimpose programs on a carrier wave and distribute the programs via a communication network. For example, the programs may be posted on a bulletin board system (BBS) on the communication network and distributed via the network. It may be configured such that the above-described processing can be performed by starting the distributed programs and executing the programs in a similar manner to other application programs under the control of the operating system.

The various aspects of the present disclosure are described as Appendices.

### APPENDIX 1

A server device, comprising one or more processors,
wherein the processors
generate product information in which a product put up for sale on an electronic flea market is arranged in a predetermined order according to access to the electronic flea market by a user,
acquire access information to the electronic flea market from a seller of a product put up for sale on the electronic flea market,
rearrange an arrangement of a product indicated by the generated product information, based on the acquired access information, and
provide the user with the product information after an arrangement is rearranged.

### APPENDIX 2

The server device according to appendix 1, wherein the processors
identify a seller satisfying a predetermined low access condition, based on the acquired access information,
and decrease an arrangement priority of a product of the identified seller among products indicated by the generated product information.

### APPENDIX 3

The server device according to appendix 2, wherein the processors
generate the product information to an effect that a display form of the product having the arrangement priority decreased is displayed in a special form that enables the user to visually recognize that the product is the product having the arrangement priority decreased, and
display a display form of the product having the arrangement priority decreased in the special form by providing the user with the product information to an effect that display is performed in the special form.

### APPENDIX 4

The server device according to appendix 1, wherein the processors
identify a seller satisfying a predetermined low access condition, based on the acquired access information, increase an arrangement priority of a product of an identified seller among products indicated by generated product information, generate the product information to an effect that a display form of the product having the arrangement priority increased is displayed in a special form that enables the user to visually recognize that the product is the product having the arrangement priority increased, and
display a display form of the product having the arrangement priority increased in the special form by providing the user with the product information to an effect that display is performed in the special form.

### APPENDIX 5

The server device according to appendix 1, wherein the processors identify a seller satisfying a predetermined high access condition, based on the acquired access information and increase an arrangement priority of a product of an identified seller among products indicated by the generated product information.

### APPENDIX 6

The server device according to appendix 2 or 3, wherein the processors
acquire a latest access date to the electronic flea market from the seller as the access information, and
identify a seller who has the latest access date satisfying a predetermined condition as a seller satisfying the low access condition.

### APPENDIX 7

The server device according to appendix 2 or 3, wherein the processors
acquire access frequency to the electronic flea market from the seller as the access information, and
identify a seller who has the access frequency satisfying a predetermined low frequency condition as a seller satisfying the low access condition.

### APPENDIX 8

The server device according to appendix 2 or 3, wherein the processors identify a seller who has not logged in for a predetermined removal period from the acquired access information and bring a state of a product of an identified seller back to a drafted state that is a state before the product is put up for sale.

### APPENDIX 9

The server device according to appendix 8, wherein the processors, in a case of bringing a state of a product back to the drafted state, notify the seller to an effect that the state of the product is brought back to the drafted state.

### APPENDIX 10

A service providing method to be performed by a server device, the service providing method comprising:
generating product information in which a product put up for sale on an electronic flea market is arranged in a predetermined order according to access to the electronic flea market by a user,
acquiring access information to the electronic flea market from a seller of a product put up for sale on the electronic flea market,
rearranging an arrangement of a product indicated by the generated product information, based on the acquired access information, and
providing the user with the product information after an arrangement is rearranged.

### APPENDIX 11

A non-transitory computer-readable recording medium storing a program for causing a computer to perform processing comprising:
generating product information in which a product put up for sale on an electronic flea market is arranged in a predetermined order according to access to the electronic flea market by a user,
acquiring access information to the electronic flea market from a seller of a product put up for sale on the electronic flea market,
rearranging an arrangement of a product indicated by the generated product information, based on the acquired access information, and
providing the user with the product information after an arrangement is rearranged.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

According to the present disclosure, a server device, a service providing method, and a recording medium that are capable of improving convenience for a user can be provided.

1. A server device, comprising one or more processors,
wherein the processors
generate product information in which a product put up for sale on an electronic flea market is arranged in a predetermined order according to access to the electronic flea market by a user,
acquire access information to the electronic flea market from a seller of a product put up for sale on the electronic flea market,
rearrange an arrangement of a product indicated by the generated product information, based on the acquired access information, and
provide the user with the product information after an arrangement is rearranged.

2. The server device according to claim 1, wherein the processors
identify a seller satisfying a predetermined low access condition, based on the acquired access information,
and decrease an arrangement priority of a product of the identified seller among products indicated by the generated product information.

3. The server device according to claim 2, wherein the processors
generate the product information to an effect that a display form of the product having the arrangement priority decreased is displayed in a special form that enables the user to visually recognize that the product is the product having the arrangement priority decreased, and
display a display form of the product having the arrangement priority decreased in the special form by providing the user with the product information to an effect that display is performed in the special form.

4. The server device according to claim 1, wherein the processors
identify a seller satisfying a predetermined low access condition, based on the acquired access information, increase an arrangement priority of a product of an identified seller among products indicated by generated product information, generate the product information to an effect that a display form of the product having the arrangement priority increased is displayed in a special form that enables the user to visually recognize that the product is the product having the arrangement priority increased, and
display a display form of the product having the arrangement priority increased in the special form by providing the user with the product information to an effect that display is performed in the special form.

5. The server device according to claim 1, wherein the processors identify a seller satisfying a predetermined high access condition, based on the acquired access information and increase an arrangement priority of a product of an identified seller among products indicated by the generated product information.

6. The server device according to claim 2, wherein the processors
acquire a latest access date to the electronic flea market from the seller as the access information, and
identify a seller who has the latest access date satisfying a predetermined condition as a seller satisfying the low access condition.

7. The server device according to claim 2, wherein the processors
acquire access frequency to the electronic flea market from the seller as the access information, and
identify a seller who has the access frequency satisfying a predetermined low frequency condition as a seller satisfying the low access condition.

8. The server device according to claim 2, wherein the processors identify a seller who has not logged in for a predetermined removal period from the acquired access information and bring a state of a product of an identified seller back to a drafted state that is a state before the product is put up for sale.

9. The server device according to claim 8, wherein the processors, in a case of bringing a state of a product back to the drafted state, notify the seller to an effect that the state of the product is brought back to the drafted state.

10. A service providing method to be performed by a server device, the service providing method comprising:
generating product information in which a product put up for sale on an electronic flea market is arranged in a predetermined order according to access to the electronic flea market by a user,
acquiring access information to the electronic flea market from a seller of a product put up for sale on the electronic flea market,
rearranging an arrangement of a product indicated by the generated product information, based on the acquired access information, and
providing the user with the product information after an arrangement is rearranged.

11. A non-transitory computer-readable recording medium storing a program for causing a computer to perform processing comprising:
generating product information in which a product put up for sale on an electronic flea market is arranged in a predetermined order according to access to the electronic flea market by a user,
acquiring access information to the electronic flea market from a seller of a product put up for sale on the electronic flea market,
rearranging an arrangement of a product indicated by the generated product information, based on the acquired access information, and
providing the user with the product information after an arrangement is rearranged.
